(19) United States
(12) Patent Application Publication
(10) Pub. No.: US 2012/0244307 A1
(43) Pub. Date: Sep. 27, 2012

(54) SILICON CARBIDE SUBSTRATE

(75) Inventors: Tsutomu HORI, Itami-shi (JP); Shin Harada, Osaka-shi (JP); Taro Nishiguchi, Itami-shi (JP); Makoto Sasaki, Itami-shi (JP); Hiroki Inoue, Itami-shi (JP); Shinsuke Fujiwara, Itami-shi (JP)

(73) Assignee: SUMITOMO ELECTRIC INDUSTRIES, LTD., Osaka-shi (JP)

(21) Appl. No.: 13/425,889

(22) Filed: Mar. 21, 2012

Related U.S. Application Data
(60) Provisional application No. 61/466,186, filed on Mar. 22, 2011.

(30) Foreign Application Priority Data
Mar. 22, 2011 (JP) 2011-062123

(51) Int. Cl. B32B 3/14; B32B 9/00

(52) U.S. Cl. 428/56; 428/54

(57) ABSTRACT

A silicon carbide substrate includes: a base substrate having a diameter of 70 mm or greater; and a plurality of SiC substrates made of single-crystal silicon carbide and arranged side by side on the base substrate when viewed in a planar view. In other words, the plurality of SiC substrates are arranged side by side on and along the main surface of the base substrate. Further, each of the SiC substrates has a main surface opposite to the base substrate and having an off angle of 20° or smaller relative to a {0001} plane.

### BACKGROUND OF THE INVENTION

1. Field of the Invention

The present invention relates to a silicon carbide substrate, more particularly, a silicon carbide substrate allowing for reduced cost of manufacturing a semiconductor device using the silicon carbide substrate.

2. Description of the Background Art

In recent years, in order to achieve high breakdown voltage, low loss, and utilization of semiconductor devices under a high temperature environment, silicon carbide (SiC) has begun to be adopted as a material for a semiconductor device. Silicon carbide is a wide band gap semiconductor having a band gap larger than that of silicon, which has been conventionally widely used as a material for semiconductor devices. Hence, by adopting silicon carbide as a material for a semiconductor device, the semiconductor device can have a high breakdown voltage, reduced on-resistance, and the like. Further, the semiconductor device thus adopting silicon carbide as its material has characteristics less deteriorated even under a high temperature environment than those of a semiconductor device adopting silicon as its material, advantageously.

Under such circumstances, various studies have been conducted and various ideas have been proposed with regard to a method for manufacturing a silicon carbide crystal and a silicon carbide substrate each used to manufacture a semiconductor device (for example, see US Patent Application Publication No. 2006/0073707 (Patent Literature 1), US Patent Application Publication No. 2007/0209577 (Patent Literature 2), and US Patent Application Publication No. 2006/0075958 (Patent Literature 3)).

However, silicon carbide does not have a liquid phase at an atmospheric pressure. In addition, crystal growth temperature thereof is 2000° C. or greater, which is very high. This makes it difficult to control and stabilize growth conditions. Accordingly, it is difficult for a silicon carbide single-crystal to have a large diameter while maintaining its quality to be high. Hence, it is not easy to obtain a high-quality silicon carbide substrate having a large diameter. This difficulty in fabricating such a silicon carbide substrate having a large diameter results in not only increased manufacturing cost of the silicon carbide substrate but also fewer semiconductor devices produced for one batch using the silicon carbide substrate. Accordingly, manufacturing cost of the semiconductor devices is increased, disadvantageously.

### SUMMARY OF THE INVENTION

In view of this, an object of the present invention is to provide a silicon carbide substrate allowing for reduced cost of manufacturing a semiconductor device using the silicon carbide substrate.

A silicon carbide substrate according to the present invention includes: a base substrate having a diameter of 70 mm or greater; and a plurality of SiC substrates each made of single-crystal silicon carbide and arranged side by side on the base substrate when viewed in a planar view. Each of the SiC substrates has a main surface opposite to the base substrate and having an off angle of 20° or smaller relative to a {0001} plane.

As described above, it is difficult for a high-quality silicon carbide single-crystal to have a large diameter. To address this, in the silicon carbide substrate of the present invention, on the base substrate having such a large diameter, i.e., a diameter of 70 mm or greater, the plurality of SiC substrates each made of single-crystal silicon carbide are arranged side by side when viewed in a planar view. Explaining from a different point of view, the SiC substrates are arranged on and along the main surface of the base substrate.

Thus, the plurality of SiC substrates each made of high-quality silicon carbide single-crystal with an insufficient size can be arranged side by side on a base substrate having a large diameter and made of low-quality silicon carbide crystal having a large defect density, or a base substrate having a large diameter and made of an appropriate material other than silicon carbide, for example. Such a silicon carbide substrate can be handled as a substrate having a high-quality SiC layer and having a large diameter. By using such a silicon carbide substrate, the process of manufacturing a semiconductor device can be improved in efficiency. Further, in the silicon carbide substrate of the present invention, the main surface of each of the SiC substrates opposite to the base substrate has an off angle of 20° or smaller relative to the {0001} plane. Accordingly, in the process of manufacturing the semiconductor device, an epitaxial growth layer can be readily formed on the main surface of the SiC substrate while restraining generation of surface defects.

As such, according to the silicon carbide substrate of the present invention, there can be provided a silicon carbide substrate allowing for reduced cost of manufacturing semiconductor devices using the silicon carbide substrate.

It should be noted that in order to improve the efficiency of the process of manufacturing a semiconductor device, it is preferable that adjacent ones of the plurality of SiC substrates are arranged in contact with one another. More specifically, for example, the plurality of SiC substrates are preferably arranged in contact with one another in the form of a matrix. Further, each of adjacent SiC substrates preferably has an end surface substantially perpendicular to the main surface of the SiC substrate. In this way, the silicon carbide substrate can be readily manufactured. Here, for example, when the end surface and the main surface form an angle of not less than 85° and not more than 95°, it can be determined that the end surface and the main surface are substantially perpendicular to each other.

In the silicon carbide substrate, the base substrate and each of the SiC substrates may be in contact with each other. Accordingly, for example, even when a vertical type semiconductor device, in which current flows in the thickness direction of the silicon carbide substrate, is manufactured using the silicon carbide substrate, current can directly flow between the SiC substrate and the base substrate.

In the silicon carbide substrate, the base substrate may be made of silicon carbide. This achieves reduced difference in physical property such as a linear expansion coefficient between the SiC substrate and the base substrate. As a result, there can be obtained a silicon carbide substrate stable in the process of manufacturing the semiconductor device. It should be noted that the base substrate may be made of single-crystal silicon carbide or may be made of polycrystal silicon carbide (inclusive of a silicon carbide sintered compact).

In the silicon carbide substrate, crystal may be discontinuous between the base substrate and each of the SiC substrates. In this way, a combination of the crystal constituting the SiC substrate and the crystal constituting the base substrate can be selected freely. It should be noted that the state in which the crystal is discontinuous refers to a state in which the base substrate is made of single-crystal silicon carbide and the plane orientation of each of the SiC substrates and the plane orientation of the base substrate are different from each other in a surface in which the plurality of SiC substrates and the base substrate are in contact with each other; or a state in which the base substrate is made of polycrystal silicon carbide.

In the silicon carbide substrate, defects may be discontinuous between the base substrate and each of the SiC substrates. In this way, defects in the base substrate are restrained from being propagated into the SiC substrate, whereby the high quality of the SiC substrate (i.e., with smaller defects) can be maintained even when the base substrate having relatively low quality (i.e., with relatively larger defects) is employed.

In the silicon carbide substrate, the base substrate may have a diameter of 4 inch or greater. In this way, the process of manufacturing the semiconductor device can become more efficient.

In the silicon carbide substrate, the main surface of each of the SiC substrates opposite to the base substrate may have an off angle of 5° or greater relative to a {0001} plane. This facilitates step-flow growth during formation of an epitaxial growth layer on the SiC substrate in the process of manufacturing the semiconductor device, thereby restraining occurrence of step bunching.

Further, each of the SiC substrates may have a micro pipe density of 1 cm⁻² or smaller. Further, the SiC substrate may have a dislocation density of 1×10⁴ cm⁻² or smaller. Further, the SiC substrate may have a stacking fault density of 0.1 cm⁻¹ or smaller. With such a high-quality SiC substrate being employed, a high-quality epitaxial growth layer can be readily formed on the SiC substrate. Further, the SiC substrate may have an impurity concentration of 5×10¹⁸ cm⁻³ or smaller. In this way, a high-quality SiC substrate with small defects can be readily obtained.

As apparent from the description above, according to the silicon carbide substrate of the present invention, there can be provided a silicon carbide substrate allowing for reduced cost of manufacturing a semiconductor device using the silicon carbide substrate.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross sectional view showing a structure of a silicon carbide substrate.

FIG. 2 is a flowchart schematically showing a method for manufacturing the silicon carbide substrate.

FIG. 3 is a flowchart schematically showing another method for manufacturing the silicon carbide substrate.

FIG. 4 is a schematic cross sectional view for illustrating the method for manufacturing the silicon carbide substrate.

FIG. 5 is a schematic cross sectional view for illustrating the method for manufacturing the silicon carbide substrate.

FIG. 6 is a schematic cross sectional view for illustrating the method for manufacturing the silicon carbide substrate.

FIG. 7 is a schematic cross sectional view showing another structure of the silicon carbide substrate.

FIG. 8 is a flowchart schematically showing a method for manufacturing the silicon carbide substrate of FIG. 7.

FIG. 9 is a schematic cross sectional view showing still another structure of the silicon carbide substrate.

FIG. 10 is a flowchart schematically showing a method for manufacturing the silicon carbide substrate of FIG. 9.

FIG. 11 is a schematic cross sectional view showing a structure of a vertical type MOSFET.

FIG. 12 is a flowchart schematically showing a method for manufacturing the vertical type MOSFET.

FIG. 13 is a schematic cross sectional view for illustrating the method for manufacturing the vertical type MOSFET.

FIG. 14 is a schematic cross sectional view for illustrating the method for manufacturing the vertical type MOSFET.

FIG. 15 is a schematic cross sectional view for illustrating the method for manufacturing the vertical type MOSFET.

### DESCRIPTION OF THE PREFERRED EMBODIMENTS

The following describes embodiments of the present invention with reference to figures. It should be noted that in the below-mentioned figures, the same or corresponding portions are given the same reference characters and are not described repeatedly. Further, in the present specification, an individual orientation is represented by [ ], a group orientation is represented by < >, and an individual plane is represented by ( ) and a group plane is represented by { }. In addition, a negative index is supposed to be crystallographically indicated by putting “-” (bar) above a numeral, but is indicated by putting the negative sign before the numeral in the present specification.

### First Embodiment

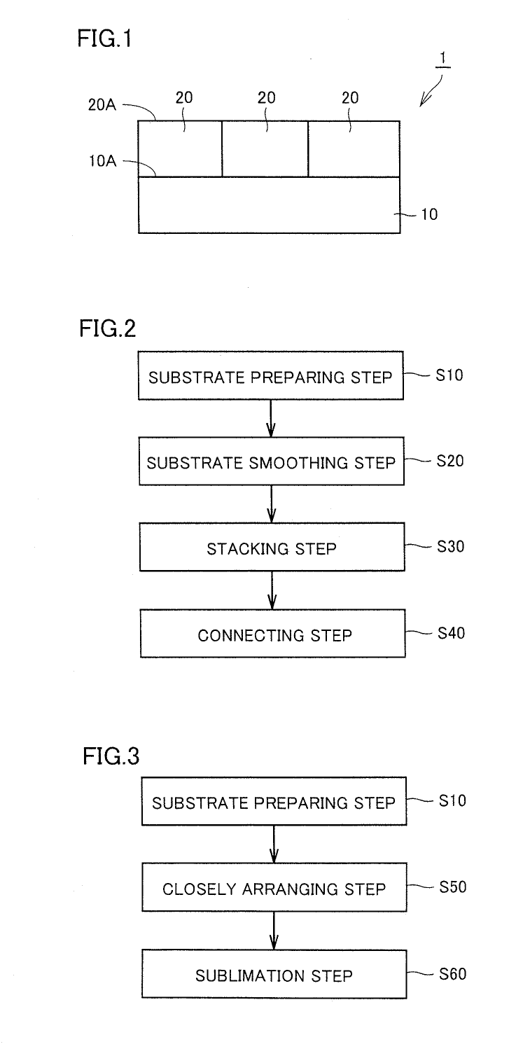

First, the following describes a first embodiment, which is one embodiment of the present invention. Referring to FIG. 1, a silicon carbide substrate 1 in the present embodiment includes: a base substrate 10 formed of silicon carbide (for example, single-crystal silicon carbide) having a diameter of 70 mm or greater; and a plurality of SiC substrates 20 each made of single-crystal silicon carbide and arranged side by side on base substrate 10 when viewed in a planar view. Each of SiC substrates 20 has a main surface 20A opposite to base substrate 10 and having an off angle of 20° or smaller relative to a {0001} plane.

In silicon carbide substrate 1 of the present embodiment, the plurality of SiC substrates 20 each made of single-crystal silicon carbide are arranged side by side on base substrate 10 having such a large diameter, i.e., a diameter of 70 mm or greater, when viewed in a planar view. Hence, for example, the plurality of high-quality SiC substrates each insufficient in size can be arranged side by side on base substrate 10 having the large diameter and made of low-quality silicon carbide crystal having large defect density. Accordingly, silicon carbide substrate 1 can be handled as a substrate having a large diameter and having a high-quality SiC layer. Utilization of such a silicon carbide substrate 1 allows for efficient manufacturing process of semiconductor devices.

Further, main surface 20A of each of SiC substrates 20 opposite to base substrate 10 has an off angle of 20° or smaller relative to the {0001} plane. Accordingly, in the process of manufacturing the semiconductor device, an epitaxial growth layer can be readily formed on main surface 20A of SiC substrate 20 while restraining generation of surface defects.

Thus, silicon carbide substrate 1 in the present embodiment is a silicon carbide substrate allowing for reduced cost of manufacturing semiconductor devices using the silicon carbide substrate.

Further, in silicon carbide substrate 1 of the present embodiment, base substrate 10 and SiC substrate 20 are connected to each other as shown in FIG. 1. Accordingly, even when a vertical type semiconductor device is manufactured using silicon carbide substrate 1, current can directly flow between SiC substrate 20 and base substrate 10.

Further, in silicon carbide substrate 1 of the present embodiment, base substrate 10 is made of silicon carbide. This results in reduced difference in physical property such as a linear expansion coefficient between SiC substrate 20 and base substrate 10. As a result, silicon carbide substrate 1 is stable in a semiconductor device manufacturing process including a step of heating it to a high temperature.

Here, in silicon carbide substrate 1, the crystal may be discontinuous between base substrate 10 and SiC substrate 20. In this way, a combination of the crystal constituting SiC substrate 20 and the crystal constituting base substrate 10 can be selected freely.

Further, in silicon carbide substrate 1, defects may be discontinuous between base substrate 10 and SiC substrate 20. In this way, defects in base substrate 10 are restrained from being propagated into SiC substrate 20, whereby the high quality of SiC substrate 20 can be maintained even when base substrate 10 having relatively low quality is employed.

Further, in silicon carbide substrate 1, base substrate 10 preferably has a diameter of 4 inch or greater, more preferably, 6 inch or greater. In this way, the process of manufacturing the semiconductor device can become more efficient.

Further, in silicon carbide substrate 1, main surface 20A of SiC substrate 20 may have an off angle of 5° or greater relative to the {0001} plane. This facilitates step-flow growth during formation of an epitaxial growth layer on SiC substrate 20 in the process of manufacturing the semiconductor device, thereby restraining occurrence of step bunching. Meanwhile, main surface 20A of SiC substrate 20 may have an off angle smaller than 10° relative to the {0001} plane. This further facilitates the formation of the epitaxial growth layer on main surface 20A of SiC substrate 20 in the process of manufacturing the semiconductor device, while restraining generation of surface defects.

The following describes an exemplary method for manufacturing silicon carbide substrate 1 described above. Referring to FIG. 2, in the method for manufacturing the silicon carbide substrate in the present embodiment, first, as a step (S10), a substrate preparing step is performed. In this step (S10), a base substrate 10 formed of silicon carbide and a plurality of SiC substrates 20 each formed of single-crystal silicon carbide are prepared, for example. Each of SiC substrates 20 has its main surface, which will be main surface 20A of silicon carbide substrate 1 that will be obtained by this manufacturing method (see FIG. 1). Hence, on this occasion, the plane orientation of the main surface of SiC substrate 20 is selected in accordance with desired plane orientation of main surface 20A. Prepared here are, for example, SiC substrates 20 each having its main surface having an off angle of approximately 8° relative to the {0001} plane. Meanwhile, a substrate having an impurity concentration greater than, for example, 2×10¹⁹ cm⁻³ is adopted as base substrate 10. Meanwhile, for each SiC substrate 20, there is adopted a substrate having an impurity concentration greater than 5×10¹⁸ cm⁻³ and smaller than 2×10¹⁹ cm⁻³, for example.

Next, a substrate smoothing step is performed as a step (S20). In this step (S20), respective main surfaces (connection surface) of base substrate 10 and SiC substrate 20 are smoothed by, for example, polishing. The main surfaces are to be brought into contact with each other in a below-described step (S30). It should be noted that this step (S20) is not an essential step, but if performed, reduces a gap between base substrate 10 and SiC substrate 20 face to face with each other and accordingly provides a uniform space therebetween. Accordingly, in a below-described step (S40), uniformity will be improved in reaction (connection) within the connection surface. This allows base substrate 10 and SiC substrate 20 to be connected to each other more securely. In order to connect base substrate 10 and SiC substrate 20 to each other further securely, the above-described connection surface preferably has a surface roughness Ra of less than 100 nm, more preferably, less than 50 nm. Further, by setting surface roughness Ra of the connection surface at less than 10 nm, more secure connection can be achieved.

Next, a stacking step is performed as step (S30). In this step (S30), the plurality of SiC substrates 20 are placed on and in contact with main surface 10A of base substrate 10, thereby fabricating a stacked substrate.

Next, as step (S40), a connecting step is performed. In step (S40), base substrate 10 and SiC substrate 20 are connected to each other by heating the stacked substrate. With the above-described process, silicon carbide substrate 1 in the first embodiment can be readily manufactured.

Here, in the stacked substrate fabricated in step (S30), the gap formed between base substrate 10 and SiC substrate 20 is preferably 100 μm or smaller. Even when each of base substrate 10 and SiC substrate 20 has a high surface smoothness, each of base substrate 10 and SiC substrates 20 has slight warpage, undulation, or the like. This results in formation of a gap between base substrate 10 and each of SiC substrates 20 in the stacked substrate. When this gap exceeds 100 μm, the connection state between base substrate 10 and SiC substrate 20 may become non-uniform. In view of this, by setting the gap between base substrate 10 and SiC substrate 20 to be not more than 100 μm, base substrate 10 and SiC substrate 20 can be uniformly connected to each other more securely.

Further, in step (S40) described above, it is preferable to heat the stacked substrate to fall within a range of temperature equal to or higher than the sublimation temperature of silicon carbide. This allows base substrate 10 and SiC substrate 20 to be connected to each other more securely. In particular, by setting the gap to be 100 μm or smaller between base substrate 10 and SiC substrate 20 in the stacked substrate, uniform connection therebetween can be achieved by means of sublimation of SiC.

Further, heating temperature for the stacked substrate in step (S40) is preferably not less than 1800° C. and not more than 2500° C. If the heating temperature is lower than 1800° C., it takes a long time to connect base substrate 10 and SiC substrate 20, which results in decreased efficiency in manufacturing silicon carbide substrate 1. On the other hand, if the heating temperature exceeds 2500° C., surfaces of base substrate 10 and SiC substrate 20 become rough, which may result in generation of a multiplicity of crystal defects in silicon carbide substrate 1 to be fabricated. In order to improve efficiency in manufacturing while further restraining generation of defects in silicon carbide substrate 1, the heating temperature for the stacked substrate in step (S40) is preferably set at not less than 1900° C. and not more than 2100° C. Further, the atmosphere upon the heating in step (S40) is preferably inert gas atmosphere. The inert gas atmosphere more preferably contains at least one selected from a group consisting of argon, helium, and nitrogen.

### Second Embodiment

The following describes another embodiment of the present invention, i.e., a second embodiment. Referring to FIG. 1, a silicon carbide substrate 1 in the second embodiment has basically the same structure and provides basically the same effects as those of silicon carbide substrate 1 in the first embodiment. However, silicon carbide substrate 1 in the second embodiment is different from that of the first embodiment in terms of its manufacturing method.

Referring to FIG. 3, in the method for manufacturing silicon carbide substrate 1 in the second embodiment, first, as a step (S10), a substrate preparing step is performed. In step (S10), a plurality of SiC substrates are prepared as with the first embodiment, and a material substrate made of silicon carbide is prepared.

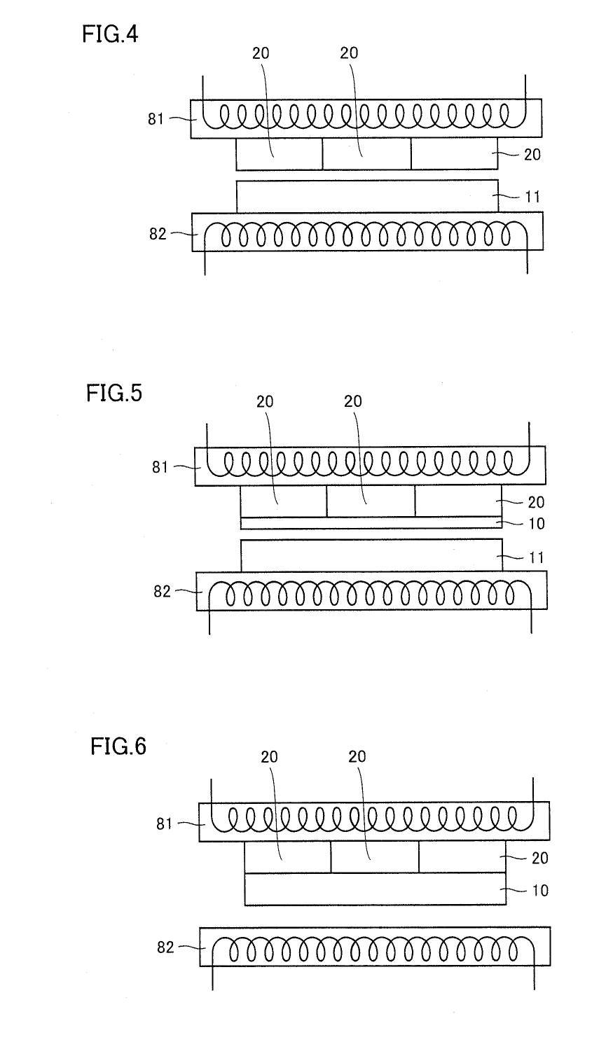

Next, referring to FIG. 3, a closely arranging step is performed as a step (S50). In this step (S50), referring to FIG. 4, each SiC substrate 20 and material substrate 11 are respectively held by a first heater 81 and a second heater 82 arranged face to face with each other. In doing so, SiC substrate 20 and material substrate 11 are arranged close to each other such that their main surfaces face each other with a space of not less than 1 μm and not more than 1 cm interposed therebetween, for example, a space of approximately 1 mm interposed therebetween.

Next, as step (S60), a sublimation step is performed. In this step (S60), SiC substrate 20 is heated to a predetermined substrate temperature by first heater 81. Further, material substrate 11 is heated to a predetermined material temperature by second heater 82. On this occasion, material substrate 11 is heated to reach the material temperature, thereby sublimating SiC from the surface of the material substrate. On the other hand, the substrate temperature is set lower than the material temperature. Specifically, for example, the substrate temperature is set lower than the material temperature by not less than 1° C. and not more than 100° C. The substrate temperature is, for example, not less than 1800° C. and not more than 2500° C. Accordingly, as shown in FIG. 5, SiC sublimated from material substrate 11 in the form of gas reaches the surface of SiC substrate 20 and is accordingly solidified thereon, thereby forming base substrate (base layer) 10. With this state being maintained, as shown in FIG. 6, all the SiC constituting material substrate 11 is sublimated and is transferred onto the surface of SiC substrate 20. Accordingly, step (S60) is completed, thereby completing silicon carbide substrate 1 shown in FIG. 1.

### Third Embodiment

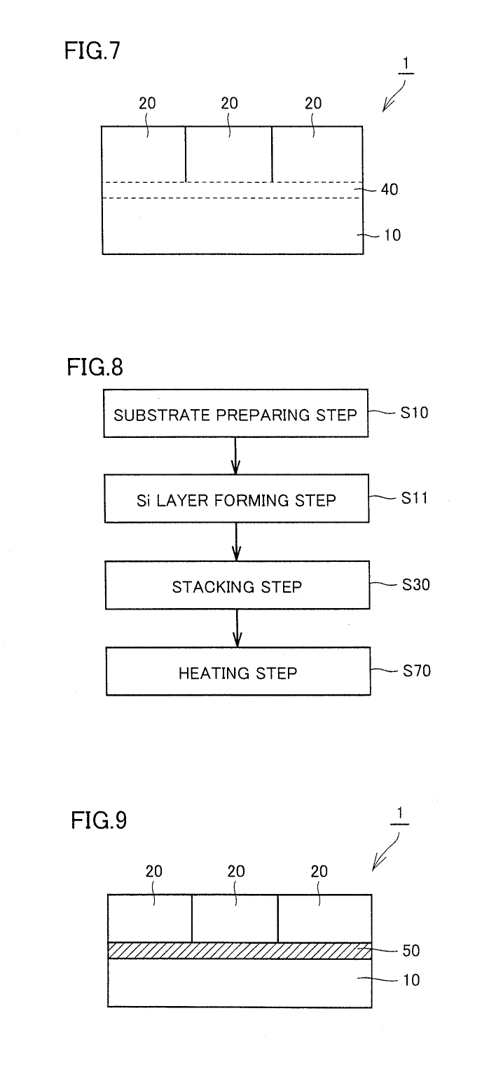

The following describes still another embodiment of the present invention, i.e., a third embodiment. Referring to FIG. 7, a silicon carbide substrate 1 in the third embodiment has basically the same configuration and provides basically the same effects as those of silicon carbide substrate 1 in the first embodiment. However, silicon carbide substrate 1 in the third embodiment is different from that of the first embodiment in that a SiC connecting layer 40 serving as an intermediate layer is provided between base substrate 10 and each SiC substrate 20.

Namely, in silicon carbide substrate 1 in the third embodiment, SiC connecting layer 40 is disposed between base substrate 10 and SiC substrate 20 as an intermediate layer made of silicon carbide. Then, base substrate 10 and SiC substrate 20 are connected to each other by this SiC connecting layer 40. SiC connecting layer 40 thus existing facilitates fabrication of silicon carbide substrate 1 in which base substrate 10 and SiC substrate 20 are stacked on each other.

The following describes a method for manufacturing silicon carbide substrate 1 in the third embodiment. Referring to FIG. 8, in the method for manufacturing silicon carbide substrate 1 in the third embodiment, the substrate preparing step is performed as step (S10) in the same way as in the first embodiment, so as to prepare base substrate 10 and the plurality of SiC substrates 20.

Next, a Si layer forming step is performed as a step (S11). In this step (S11), a Si layer having a thickness of approximately 100 nm is formed on one main surface of base substrate 10 prepared in step (S10), for example. This Si layer can be formed using a sputtering method, for example.

Next, a stacking step is performed as step (S30). In this step (S30), the plurality of SiC substrates 20 prepared in step (S10) are placed side by side on the Si layer formed in step (S11) when viewed in a planar view. In this way, a stacked substrate is obtained in which SiC substrate 20 is provided over base substrate 10 with the Si layer interposed therebetween.

Next, as a step (S70), a heating step is performed. In this step (S70), the stacked substrate fabricated in step (S30) is heated, for example, in a mixed gas atmosphere of hydrogen gas and propane gas under a pressure of 1×10³ Pa at approximately 1500° C. for approximately 3 hours. Accordingly, the Si layer is supplied with carbon as a result of diffusion mainly from base substrate 10 and SiC substrate 20, thereby forming SiC connecting layer 40 as shown in FIG. 9. Accordingly, silicon carbide substrate 1 of the third embodiment can be readily manufactured in which base substrate 10 and SiC substrate 20 are connected to each other by SiC connecting layer 40.

### Fourth Embodiment

The following describes yet another embodiment of the present invention, i.e., a fourth embodiment. Referring to FIG. 9, a silicon carbide substrate 1 in the fourth embodiment has basically the same configuration and provides basically the same effects as those of silicon carbide substrate 1 in the first embodiment. However, silicon carbide substrate 1 in the fourth embodiment is different from that of the first embodiment in that an ohmic contact layer 50 serving as an intermediate layer is provided between base substrate 10 and each SiC substrate 20.

Namely, in silicon carbide substrate 1 of the fourth embodiment, between base substrate 10 and SiC substrate 20, ohmic contact layer 50 is disposed as an intermediate layer formed by siliciding at least a portion of a metal layer. Then, base substrate 10 and SiC substrate 20 are connected to each other by this ohmic contact layer 50. Ohmic contact layer 50 thus existing facilitates fabrication of silicon carbide substrate 1 in which base substrate 10 and SiC substrate 20 are stacked on each other.

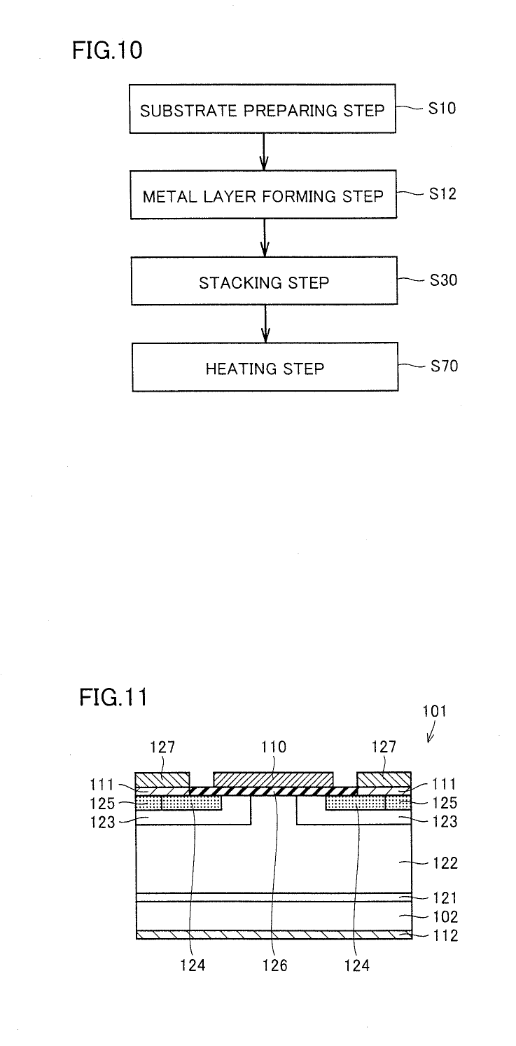

The following describes a method for manufacturing silicon carbide substrate 1 in the fourth embodiment. Referring to FIG. 10, in the method for manufacturing silicon carbide substrate 1 in the fourth embodiment, the substrate preparing step is performed as step (S10) in the same way as in the first embodiment, so as to prepare base substrate 10 and the plurality of SiC substrates 20.

Next, a metal layer forming step is performed as a step (S12). In this step (S12), the metal layer is formed by, for example, depositing the metal on one main surface of base substrate 10 prepared in step (S10). This metal layer includes a metal forming silicide when being heated, such as at least one or more selected from nickel, molybdenum, titanium, aluminum, and tungsten.

Next, a stacking step is performed as step (S30). In this step (S30), the plurality of SiC substrates 20 prepared in step (S10) are placed on the metal layer formed in step (S12). In this way, a stacked substrate is obtained in which SiC substrate 20 is provided over base substrate 10 with the metal layer interposed therebetween.

Next, as a step (S70), a heating step is performed. In this step (S70), the stacked substrate fabricated in step (S30) is heated to approximately 1000° C. in an inert gas atmosphere such as argon, for example. In this way, at least portions of the metal layer (the region making contact with base substrate 10 and the region making contact with the SiC substrate) are silicided to form ohmic contact layer 50. Accordingly, silicon carbide substrate 1 of the fifth embodiment can be readily manufactured in which base substrate 10 and SiC substrate 20 are connected to each other by ohmic contact layer 50.

It should be noted that it has been illustrated that SiC connecting layer 40 or ohmic contact layer 50 is employed for the intermediate layer in each of the fourth and fifth embodiments, but the intermediate layer described above is not limited to them. For example, instead of these, there can be employed a carbon adhesive agent, or a SiC-related adhesive agent made of organic compound including silicon atoms and carbon atoms in its structures and formed into silicon carbide through heat treatment. Further, base substrate 10 and SiC substrate 20 may be connected by means of heating and pressing.

It should be noted that base substrate 10 employed in each of the above-described embodiments may be made of various materials. For example, in the case where base substrate 10 is made of silicon carbide, base substrate 10 may be of any one of a sintered compact, amorphous, polycrystal, and single-crystal. In the case where base substrate 10 is formed of single-crystal, main surface 10A thereof facing SiC substrate 20 may corresponds to the {0001} plane or may have an off angle relative to the {0001} plane. In this case, the off angle can be set appropriately, and can be set at, for example, 2° or smaller, more specifically, 1° or 2°. Further, main surface 10A may correspond to a plane of Si plane side or a plane of C plane side. Here, the term “plane of Si plane side” refers to a plane forming an angle less than 90° relative to the Si plane, i.e., the (0001) plane. On the other hand, the term “plane of C plane side” refers to a plane forming an angle less than 90° relative to the C plane, i.e., the (000-1) plane.

Further, each of SiC substrates 20 in each of the above-described embodiments is made of single-crystal silicon carbide. Further, main surface 20A opposite to base substrate 10 may corresponds to the {0001} plane or may have an off angle relative to the {0001} plane. In this case, the off angle can be set appropriately, and can be set at, for example, 8° or smaller, more specifically, 8° or 4°. Alternatively, the off angle may be set at 4° or smaller such as 3° or 2°. Further, main surface 20A may correspond to a plane of the Si plane side or a plane of the C plane side.

### Fifth Embodiment

As a fifth embodiment, the following describes one exemplary semiconductor device fabricated using the above-described silicon carbide substrate of the present invention. Referring to FIG. 11, a semiconductor device 101 according to the present invention is a DiMOSFET (Double Implanted MOSFET) of vertical type, and has a substrate 102, a buffer layer 121, a breakdown voltage holding layer 122, p regions 123, n⁺ regions 124, p⁺ regions 125, an oxide film 126, source electrodes 111, upper source electrodes 127, a gate electrode 110, and a drain electrode 112 formed on the backside surface of substrate 102. Specifically, buffer layer 121 made of silicon carbide is formed on the front-side surface of substrate 102 made of silicon carbide of n type conductivity. As substrate 102, a silicon carbide substrate of the present invention, inclusive of silicon carbide substrate 1 described in each of the first to fourth embodiments, is used. In the case where silicon carbide substrate 1 in each of the first to fourth embodiments is employed, buffer layer 121 is formed on SiC substrate 20 of silicon carbide substrate 1. Buffer layer 121 has n type conductivity, and has a thickness of, for example, 0.5 μm. Further, impurity with n type conductivity in buffer layer 121 has a concentration of for example, 5×10¹⁷ cm⁻³. Formed on buffer layer 121 is breakdown voltage holding layer 122. Breakdown voltage holding layer 122 is made of silicon carbide of n type conductivity, and has a thickness of 10 μm, for example. Further, breakdown voltage holding layer 122 includes an impurity of n type conductivity at a concentration of, for example, 5×10¹⁵ cm⁻³.

Breakdown voltage holding layer 122 has a surface in which p regions 123 of p type conductivity are formed with a space therebetween. In each of p regions 123, an n⁺ region 124 is formed at the surface layer of p region 123. Further, at a location adjacent to n⁺ region 124, a p⁺ region 125 is formed. Oxide film 126 is formed to extend on n⁺ region 124 in one p region 123, p region 123, an exposed portion of breakdown voltage holding layer 122 between the two p regions 123, the other p region 123, and n⁺ region 124 in the other p region 123. On oxide film 126, gate electrode 110 is formed. Further, source electrodes 111 are formed on n⁺ regions 124 and p⁺ regions 125. On source electrodes 111, upper source electrodes 127 are formed. Moreover, drain electrode 112 is formed on the backside surface of substrate 102, i.e., the surface opposite to its front-side surface on which buffer layer 121 is formed.

In semiconductor device 101 of the present embodiment, the silicon carbide substrate of the present invention, such as silicon carbide substrate 1 described in each of the first embodiment to the fourth embodiment, is employed as substrate 102. Namely, semiconductor device 101 includes: substrate 102 serving as the silicon carbide substrate; buffer layer 121 and breakdown voltage holding layer 122 both serving as epitaxial growth layers formed on and above substrate 102; and source electrodes 111 formed on breakdown voltage holding layer 122. Further, substrate 102 is the silicon carbide substrate of the present invention such as silicon carbide substrate 1. Here, as described above, the silicon carbide substrate in the present invention allows for reduced cost in manufacturing semiconductor devices using the silicon carbide substrate. Hence, semiconductor device 101 is manufactured with the reduced manufacturing cost.

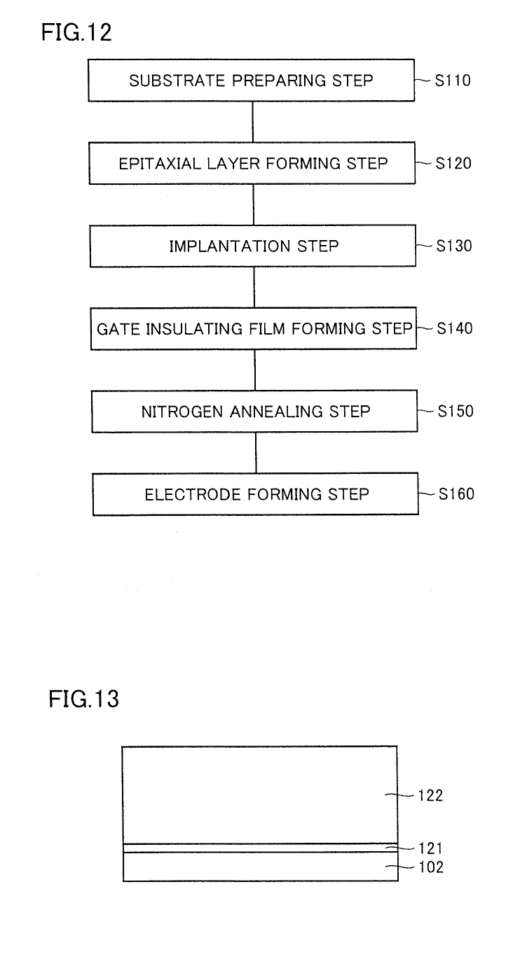

The following describes a method for manufacturing semiconductor device 101 shown in FIG. 11, with reference to FIG. 12-FIG. 15. Referring to FIG. 12, first, a substrate preparing step (S110) is performed. Prepared here is, for example, a substrate 102 (see FIG. 13) made of silicon carbide and having a main surface having an off angle of approximately 8° relative to the (0001) plane. As substrate 102, the silicon carbide substrate of the present invention inclusive of silicon carbide substrate 1 described in each of the first embodiment to the fourth embodiment is prepared.

As substrate 102 (see FIG. 13), a substrate may be employed which has n type conductivity and has a substrate resistance of 0.02 Ωcm.

Next, as shown in FIG. 12, an epitaxial layer forming step (S120) is performed. Specifically, buffer layer 121 is formed on the front-side surface of substrate 102. This buffer layer 121 is formed on SiC substrate 20 of silicon carbide substrate 1 adopted as substrate 102 (see FIG. 1, FIG. 7, and FIG. 9). As buffer layer 121, an epitaxial growth layer is formed which is made of silicon carbide of n type conductivity and has a thickness of 0.5 μm, for example. Buffer layer 121 has a conductive impurity at a concentration of, for example, 5×10¹⁷ cm⁻³. Then, on buffer layer 121, breakdown voltage holding layer 122 is formed as shown in FIG. 13. As breakdown voltage holding layer 122, a layer made of silicon carbide of n type conductivity is formed through epitaxial growth. Breakdown voltage holding layer 122 can have a thickness of, for example, 10 μm. Further, breakdown voltage holding layer 122 includes an impurity of n type conductivity at a concentration of, for example, 5×10¹⁵ cm⁻³.

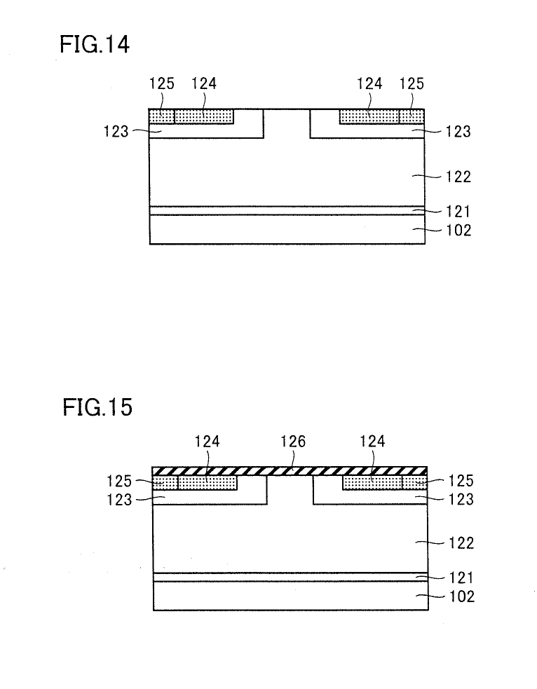

Next, as shown in FIG. 12, an implantation step (S130) is performed. Specifically, an impurity of p type conductivity is implanted into breakdown voltage holding layer 122 using, as a mask, an oxide film formed through photolithography and etching, thereby forming p regions 123 as shown in FIG. 14. Further, after removing the oxide film thus used, an oxide film having a new pattern is formed through photolithography and etching. Using this oxide film as a mask, a conductive impurity of n type conductivity is implanted into predetermined regions to form n⁺ regions 124. In a similar way, a conductive impurity of p type conductivity is implanted to form p⁺ regions 125. As a result, the structure shown in FIG. 14 is obtained.

After such an implantation step, an activation annealing process is performed. This activation annealing process can be performed under conditions that, for example, argon gas is employed as atmospheric gas, heating temperature is set at 1700° C., and heating time is set at 30 minutes.

Next, a gate insulating film forming step (S140) is performed as shown in FIG. 12. Specifically, as shown in FIG. 15, oxide film 126 is formed to cover breakdown voltage holding layer 122, p regions 123, n⁺ regions 124, and p⁺ regions 125. As a condition for forming oxide film 126, for example, dry oxidation (thermal oxidation) may be performed. The dry oxidation can be performed under conditions that the heating temperature is set at 1200° C. and the heating time is set at 30 minutes.

Thereafter, a nitrogen annealing step (S150) is performed as shown in FIG. 12. Specifically, an annealing process is performed in atmospheric gas of nitrogen monoxide (NO). Temperature conditions for this annealing process are, for example, as follows: the heating temperature is 1100° C. and the heating time is 120 minutes. As a result, nitrogen atoms are introduced into a vicinity of the interface between oxide film 126 and each of breakdown voltage holding layer 122, p regions 123, n⁺ regions 124, and p⁺ regions 125, which are disposed below oxide film 126. Further, after the annealing step using the atmospheric gas of nitrogen monoxide, additional annealing may be performed using argon (Ar) gas, which is an inert gas. Specifically, using the atmospheric gas of argon gas, the additional annealing may be performed under conditions that the heating temperature is set at 1100° C. and the heating time is set at 60 minutes.

Next, as shown in FIG. 12, an electrode forming step (S160) is performed. Specifically, referring to FIG. 11, gate electrode 110, source electrodes 111, drain electrode 112, and upper source electrodes 127 are formed to complete semiconductor device 101.

It should be noted that in the fifth embodiment, the vertical type MOSFET has been illustrated as one exemplary semiconductor device that can be fabricated using the silicon carbide substrate of the present invention, but the semiconductor device that can be fabricated is not limited to this. For example, various types of semiconductor devices can be fabricated using the silicon carbide substrate of the present invention, such as a JFET (Junction Field Effect Transistor), an IGBT (Insulated Gate Bipolar Transistor), and a Schottky barrier diode.

Further, the silicon carbide substrate of the present invention can be used to fabricate a semiconductor device as described above in the fifth embodiment. In other words, in the semiconductor device of the present invention, an epitaxial growth layer is formed on the silicon carbide substrate of the present invention as an active layer. More specifically, the semiconductor device of the present invention includes: the silicon carbide substrate of the present invention; the epitaxial growth layer formed on the silicon carbide substrate; and the electrode formed on the epitaxial growth layer. Namely, the semiconductor device of the present invention includes: the base substrate; the SiC substrate made of single-crystal silicon carbide and disposed on the base substrate; the epitaxial growth layer formed on the SiC substrate; and the electrode formed on the epitaxial layer. Further, the main surface of the SiC substrate opposite to the base substrate has an off angle of 20° or smaller relative to the {0001} plane.

The silicon carbide substrate of the present invention is advantageously applicable particularly to a silicon carbide substrate used for manufacturing of a semiconductor device required to achieve reduced manufacturing cost.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A silicon carbide substrate comprising:
a base substrate having a diameter of 70 mm or greater; and
a plurality of SiC substrates each made of single-crystal silicon carbide and arranged side by side on said base substrate when viewed in a planar view,
each of said SiC substrates having a main surface that is opposite to said base substrate and that has an off angle of 20° or smaller relative to a {0001} plane.

2. The silicon carbide substrate according to claim 1, wherein said base substrate and each of said SiC substrates are in contact with each other.

3. The silicon carbide substrate according to claim 1, wherein said base substrate is made of silicon carbide.

4. The silicon carbide substrate according to claim 3, wherein crystal is discontinuous between said base substrate and each of said SiC substrates.

5. The silicon carbide substrate according to claim 4, wherein defects are discontinuous between said base substrate and each of said SiC substrates.

6. The silicon carbide substrate according to claim 1, wherein said base substrate has a diameter of 4 inch or greater.

7. The silicon carbide substrate according to claim 1, wherein said main surface of each of said SiC substrates opposite to said base substrate has an off angle of 5° or greater relative to a {0001} plane.
